(19) United States
(12) Patent Application Publication
(10) Pub. No.: US 2015/0314797 A1
(43) Pub. Date: Nov. 5, 2015

(54) Wheelbarrow Brake Device

(71) Applicant: Mark J. Hergert, Eatonville, WA (US)

(72) Inventor: Mark J. Hergert, Eatonville, WA (US)

(21) Appl. No.: 14/267,432

(22) Filed: May 1, 2014

(51) Int. Cl. B62B 5/04; B62B 1/18

(52) U.S. Cl. CPC B62B 5/0485; B62B 5/0438; B62B 1/18

(57) ABSTRACT

A wheelbarrow brake device facilitates stopping of and enhancing control of a wheelbarrow. The device includes a wheelbarrow having a frame, a pair of handle sections extending rearwardly from the frame, a barrow coupled to and supported by the frame, and a wheel coupled to the frame. A lever is pivotally coupled to one of the handles. A brake pad is pivotally coupled to and extends from the frame. The brake pad is positioned adjacent to the wheel and is pivotable to abut the wheel. A cable is coupled to and extends between the lever and the brake pad wherein manipulation of the lever pivots the brake pad into abutment with wheel.

### BACKGROUND OF THE DISCLOSURE

### Field of the Disclosure

The disclosure relates to brake devices and more particularly pertains to a new brake device for facilitating stopping of and enhancing control of a wheelbarrow.

### SUMMARY OF THE DISCLOSURE

An embodiment of the disclosure meets the needs presented above by generally comprising a wheelbarrow having a frame, a pair of handle sections extending rearwardly from the frame, a barrow coupled to and supported by the frame, and a wheel coupled to the frame. A lever is pivotally coupled to one of the handles. A brake pad is pivotally coupled to and extends from the frame. The brake pad is positioned adjacent to the wheel and is pivotable to abut the wheel. A cable is coupled to and extends between the lever and the brake pad wherein manipulation of the lever pivots the brake pad into abutment with wheel.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is a top front side perspective view of a wheelbarrow brake device according to an embodiment of the disclosure.

FIG. 2 is a partially exploded front view of an embodiment of the disclosure.

FIG. 3 is a side view of a lever of an embodiment of the disclosure.

FIG. 4 is a front view of an embodiment of the disclosure installed on a wheelbarrow.

FIG. 5 is a side view of an embodiment of the disclosure in use.

### DESCRIPTION OF THE PREFERRED EMBODIMENT

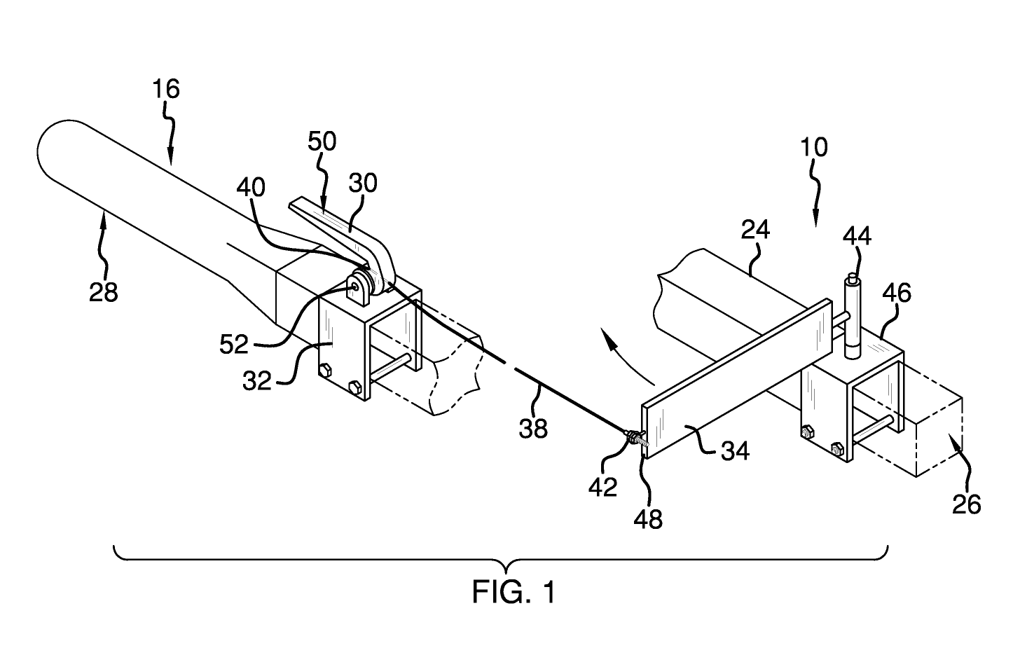

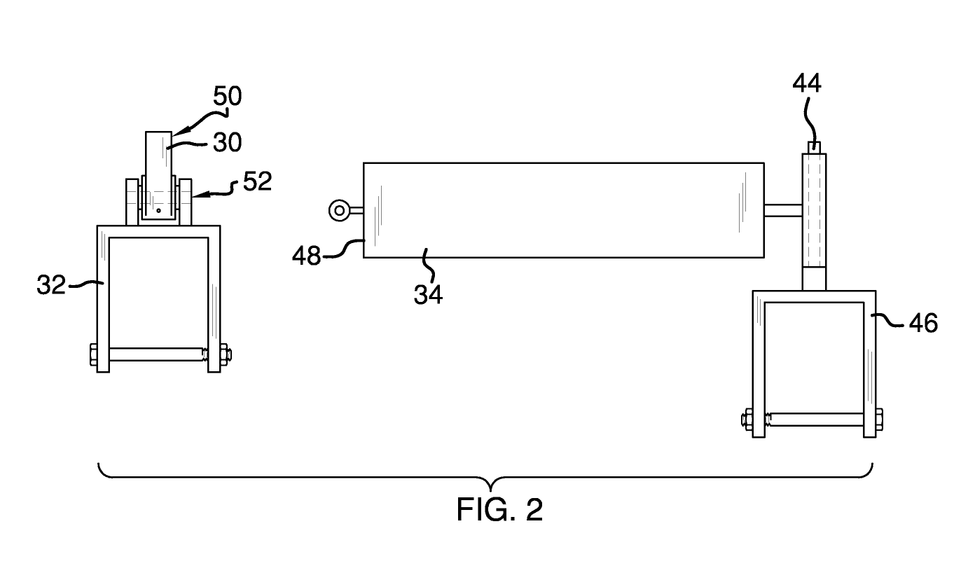

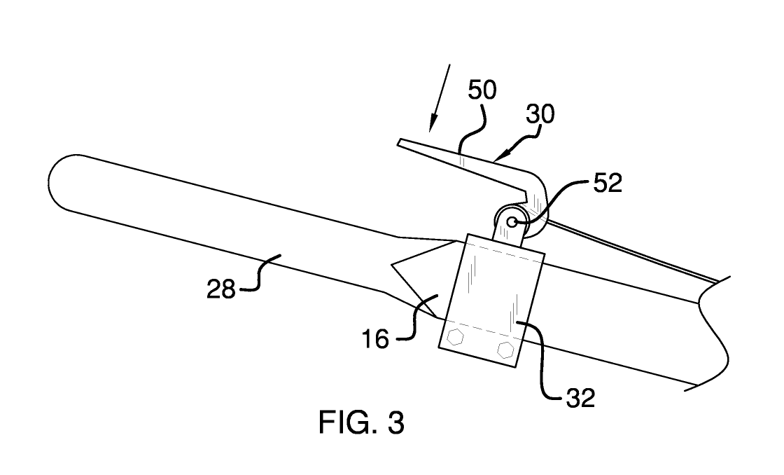

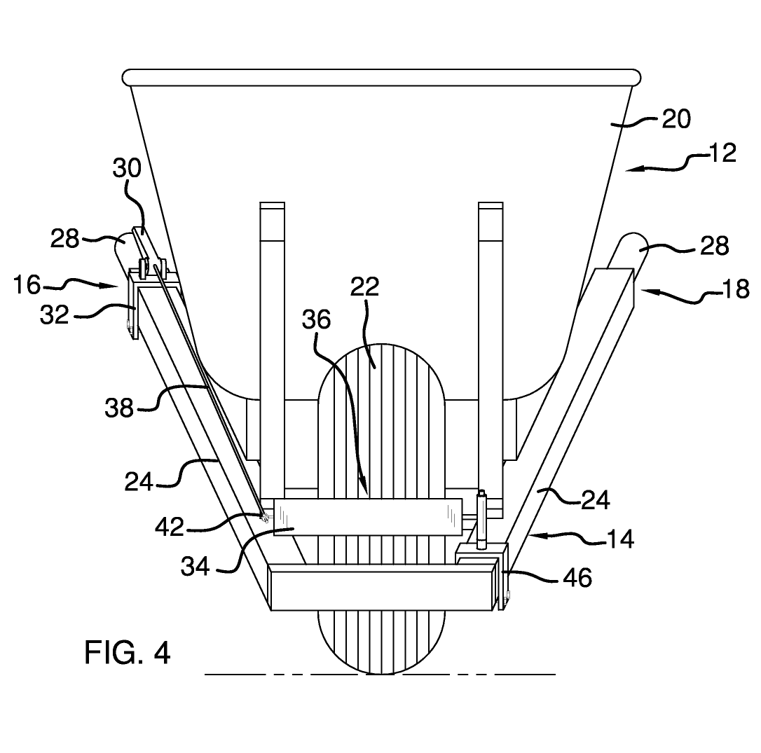

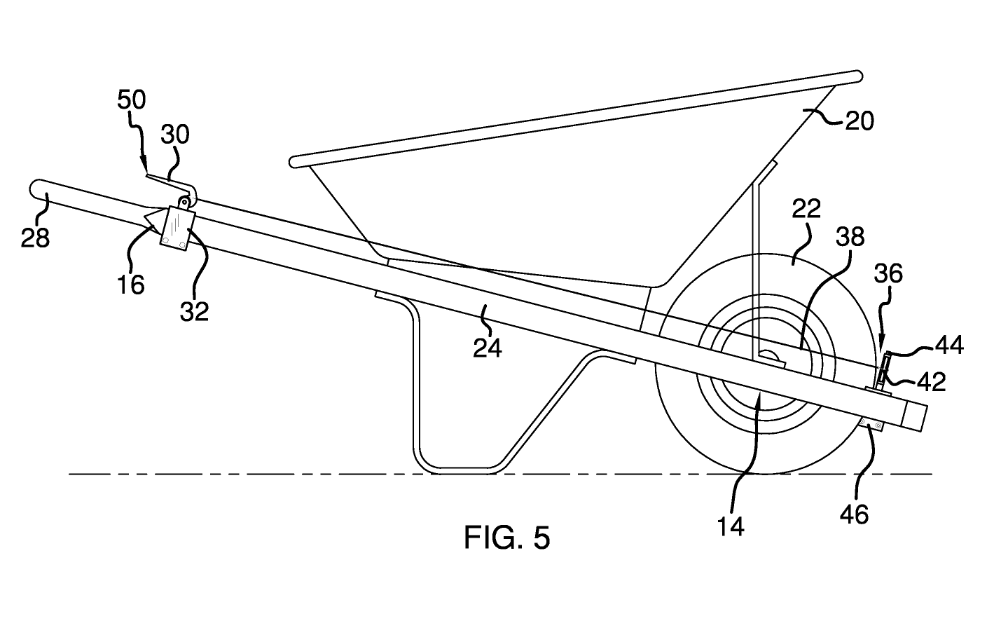

With reference now to the drawings, and in particular to FIGS. 1 through 5 thereof, a new brake device embodying the principles and concepts of an embodiment of the disclosure and generally designated by the reference numeral 10 will be described.

As best illustrated in FIGS. 1 through 5, the wheelbarrow brake device 10 generally comprises a wheelbarrow 12 having a frame 14, a pair of handles 16,18 extending rearwardly from the frame 14. A barrow 20 is coupled to and supported by the frame 14. A wheel 22 is coupled to the frame 14. The handles 16,18 may be integral extensions of the frame 14 and comprise elongated beams 24 having a rectangular cross-sectional shape 26 and rounded gripping sections 28 positioned distally relative to the frame 14. The handles 16,18 are angled such that the handles 16,18 extend downwardly and forwardly as the handles 16,18 extend towards the wheel 22. A lever 30 is pivotally coupled to a first one of the handles 16 wherein the lever 30 is configured for pivoting relative to the first one of the handles 16. This may be achieved using a lever mounting bracket 32 to which the lever 30 is pivotally coupled. The lever mounting bracket 32 is coupled to the first one of the handles 16 in a static position adjacent to the gripping section 28 of the first one of the handles 16.

A brake pad 34 is pivotally coupled to and extends from the frame 14 such that the brake pad 34 is positioned adjacent to the wheel 22 and is pivotable to abut the wheel 22. The brake pad 34 may be positioned on a forward side 36 of the wheel 22. A cable 38 is coupled to and extends between the lever 30 and the brake pad 34 wherein manipulation of the lever 30 pivots the brake pad 34 into abutment with the wheel 22 such that the brake pad 34 inhibits rotation of the wheel 22. A first end 40 of the cable 38 is coupled to the lever 30 such that the cable 38 is pulled upwardly towards the gripping section 28 of the first one of the handles 16 when the lever 30 is manipulated. A swivel post 44 is coupled to and extends from the frame 14 proximate the wheel 22. The brake pad 34 is coupled to the swivel post 44 such that the brake pad 34 is pivotally coupled to the frame 14. The swivel post 44 is angled relative to a vertical axis and the brake pad 34 positioned such that gravity urges the brake pad 34 away from the wheel 22 until the lever 30 is manipulated. A post mounting bracket 46 may be provided allowing application of the device 10 to an existing wheelbarrow apparatus. The swivel post 44 is coupled to the post mounting bracket 46 which is coupled in a static position to the frame 14. A second end 42 of the cable 38 is coupled to a distal end 48 of the brake pad 34 relative to the swivel post 44. Thus, the brake pad 34 pivots rearwardly into contact with the wheel 22 when the lever 30 is manipulated. The cable 38 extends along the first one of the handles 16.

In use, the lever 30 and brake pad 34 may be provided as original parts with, or as parts which may be coupled to an existing wheelbarrow 12. The lever 30 has a straight section 50 extending offset from a pivot point 52 and parallel to the first one of the handles 16 such that the straight section 52 may be pressed or squeezed towards the first one of the handles 16 resulting in pivoting of the brake pad 34 into contact with the wheel 22. Variations in pressure on the lever 30 vary the resistance to rotation of the wheel 22 provided by the brake pad 34 allowing for speed control as well as facilitating full stopping of the wheelbarrow 12 when desired.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded.

A reference to an element by the indefinite article “a” does not exclude the possibility that more than one of the element is present, unless the context clearly requires that there be only one of the elements.

1. A wheelbarrow brake device comprising:
a wheelbarrow having a frame, a pair of handle sections extending rearwardly from said frame, a barrow coupled to and supported by said frame, and a wheel coupled to said frame, said frame having a planar upper surface;
a lever pivotally coupled to a first one of said handles wherein said lever is configured for pivoting relative to said first one of said handles, said lever extending upwardly from a top surface of said first one of said handles;
a brake pad pivotally coupled to and extending from said frame such that said brake pad is positioned adjacent to said wheel and is pivotable to abut said wheel, said brake pad being positioned on a forward side of said wheel;
a cable coupled to and extending between said lever and said brake pad wherein manipulation of said lever pivots said brake pad into abutment with wheel such that said brake pad inhibits rotation of said wheel, said brake pad pivoting rearwardly when said lever is manipulated; and
a swivel post coupled to and extending transversely from said upper surface of said frame, said brake pad being coupled to said swivel post wherein said brake pad is pivotally coupled to said frame such that said brake pad pivots in a plane parallel to said upper surface of said frame.

2. The device of claim 1, further comprising said handles being integral extensions of said frame.

3. (canceled)

4. (canceled)

5. (canceled)

6. The device of claim 1, further comprising said swivel post being angled relative to a vertical axis such that gravity urges said brake pad away from said wheel until said lever is manipulated.

7. The device of claim 1, further comprising a post mounting bracket, said swivel post being coupled to said post mounting bracket, said post mounting bracket being coupled to said frame.

8. The device of claim 1, further comprising said handles being angled such that said handles extend downwardly and forwardly as said handles extend towards said wheel.

9. The device of claim 8, further comprising said cable extending along said first one of said handles.

10. The device of claim 1, further comprising a lever mounting bracket, said lever being coupled to said lever mounting bracket, said lever mounting bracket being coupled to said first one of said handles.

11. A wheelbarrow brake device comprising:
a wheelbarrow having a frame, said frame having a planar upper surface, a pair of handle sections extending rearwardly from said frame, a barrow coupled to and supported by said frame, and a wheel coupled to said frame, said handles being integral extensions of said frame, said handles being angled such that said handles extend downwardly and forwardly as said handles extend towards said wheel;
a lever pivotally coupled to a first one of said handles wherein said lever is configured for pivoting relative to said first one of said handles, said lever extending upwardly from a top surface of said first one of said handles;
a lever mounting bracket, said lever being coupled to said lever mounting bracket, said lever mounting bracket being coupled to said first one of said handles;
a brake pad pivotally coupled to and extending from said frame such that said brake pad is positioned adjacent to said wheel and is pivotable to abut said wheel, said brake pad being positioned on a forward side of said wheel;
a cable coupled to and extending between said lever and said brake pad wherein manipulation of said lever pivots said brake pad into abutment with wheel such that said brake pad inhibits rotation of said wheel, said brake pad pivoting rearwardly when said lever is manipulated, said cable extending along said first one of said handles;
a swivel post coupled to and extending from said frame, said brake pad being coupled to said swivel post wherein said brake pad is pivotally coupled to said frame such that said brake pad pivots in a plane parallel to said upper surface of said frame, said swivel post being angled relative to a vertical axis such that gravity urges said brake pad away from said wheel until said lever is manipulated; and
a post mounting bracket, said swivel post being coupled to said post mounting bracket, said post mounting bracket being coupled to said frame.
